(19) United States
(12) Patent Application Publication
(10) Pub. No.: US 2026/0195870 A1
(43) Pub. Date: Jul. 9, 2026

(54) PASSIVE OPTICAL METASURFACE PERFORMING ANALOG SPATIO-TEMPORAL DIFFERENTIATION FOR EVENT-BASED IMAGE PROCESSING

(71) Applicant: Research Foundation of the City University of New York, New York, NY (US)

(72) Inventors: Andrea Alù, Tenafly, NJ (US); Michele Cotrufo, New York, NY (US); Sedigheh Kouhpayehzadeh Esfahani, New York, NY (US)

(21) Appl. No.: 19/465,719

(22) Filed: Jan. 30, 2026

Related U.S. Application Data
(63) Continuation of application No. PCT/US24/38042, filed on Jul. 15, 2024.
(60) Provisional application No. 63/516,752, filed on Jul. 31, 2023.

(51) Int. Cl. G06T 5/73; G06T 5/10; G06T 7/13

(52) U.S. Cl. CPC G06T 5/73; G06T 5/10; G06T 7/13; G06T 2207/20056; G06T 2207/20192

(57) ABSTRACT

An imaging device comprises an input region that receives an input signal encoded in an envelope of an electromagnetic wave; a unit cell comprising at least one layer that is patterned to perform a spatio-temporal operation on the input signal; and an output region that generates an expected output signal that corresponds to a space-time derivative of the input signal.

### RELATED APPLICATIONS

This application claims priority to U.S. Provisional Application Ser. No. 63/516,752 filed Jul. 31, 2023, entitled “PASSIVE OPTICAL METASURFACE PERFORMING ANALOG SPATIO-TEMPORAL DIFFERENTIATION FOR EVENT-BASED IMAGE PROCESSING,” the entirety of which is incorporated by reference herein.

### STATEMENT REGARDING FEDERALLY FUNDED RESEARCH OR DEVELOPMENT

This invention was made with government support under grant number FA9550-18-1-0379 awarded by the Air Force Office of Scientific Research. The government has certain rights in the invention.

### FIELD

The present concepts relate generally to optical computing devices, and more specifically, to devices having a passive optical metasurface that can perform analog mixed spatiotemporal differentiation operation on an input image.

### BACKGROUND

Metamaterial and metasurface-based all-optical computation techniques have emerged as a promising alternative to digital computation for many technologies because of their processing speed, low-energy consumption and enhanced control over the flow of light. One promising application of metasurface-based technology relates to image processing. Edge detection is a fundamental step of image processing because it is executed to identify boundaries or transitions between different objects or regions within an image. However, significant processing resources are required which consume power. Metasurfaces have been shown to enable real time edge detection with low to no power consumption. Some approaches have been developed where a metasurface acts as a spatial-momentum filter, thus performing a desired spatial operation, e.g., spatial differentiation enabling edge detection. However, while recent studies on metamaterial-based analog computation have so far focused on spatial operations, comparatively little effort has been devoted to the implementation of temporal and, more broadly, spatio-temporal computation. Existing metasurface-based devices also pose strict constraints on operational speeds, latency times, device footprint, and power consumption. For example, in the emerging field of neuromorphic computing, neuromorphic cameras rely on sophisticated circuitry that detects changes in brightness between neighboring pixels, triggering data acquisition. These approaches are affected by limited temporal and spatial resolution and large latency, and they require active components and voltage bias, preventing miniaturization and energy savings because the active circuit-based sensors require electrical biases resulting in high power consumption.

### SUMMARY

In an aspect of the present inventive concept, an imaging device comprises an input region that receives an input signal encoded in an envelope of an electromagnetic wave; a metasurface comprising a periodic repetition of unit cells comprising at least one layer that is patterned to perform a spatio-temporal operation on the input signal; and an output region that generates an expected output signal that corresponds to a space-time derivative of the input signal.

In another aspect, an analog optical device comprises a means for transducing a spatio-temporal signal f(x,y,t) carried by an electromagnetic input signal with a carrier frequency ω₀ impinging on a first side of the analog optical device, and producing an output signal fₒᵤₜ(x,y,t) carried by an electromagnetic wave at a frequency equal to the electromagnetic input signal, the output signal being outputted from a second side of the analog optical device opposite the first side.

In another aspect, a passive optical metasurface comprising a planar metasurface comprising a means for transducing a spatio-temporal input signal f(x, y, t) to a spatio-temporal output signal

$$\frac{{\partial }^{2}}{\partial {t}^{2}} {∇}_{x , y}^{2} f ( x , y , t )$$

such that only regions of the spatio-temporal input signal f(x, y, t) with simultaneous nonzero spatial and time gradients are transduced.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention. In the drawings:

FIG. 1 is a flow diagram of a method for performing analog spatio-temporal differentiation for event-based imaging processing, in accordance with some embodiments.

FIG. 2 is an illustrative diagram of an optical device performing analog event-based spatio-temporal edge detection, in accordance with some embodiments.

FIG. 3 is a schematic diagram of a unit cell of the optical device of FIG. 2, in accordance with some embodiments.

FIG. 4 is a diagram illustrating a transfer function of a metasurface provided by the unit cell of FIG. 3.

FIG. 5 is a schematic diagram of a unit cell of the optical device of FIG. 2, in accordance with other embodiments.

FIG. 6 is a perspective view of the optical device obtained by several repetitions of the unit cell of FIG. 5.

FIG. 7A is a time-dependent one-dimension (1D) image comprising segments with fixed sizes and having intensities that are switched on and off in time, in accordance with some embodiments.

FIG. 7B is an output image generated by the metasurface when the 1D image of FIG. 7A is used as input, in accordance with some embodiments.

FIG. 7C is an output image produced by an exact spatio-temporal differentiation of the image of FIG. 7A, in accordance with some embodiments.

FIG. 7D is a time-dependent one dimensional (1D) image, in accordance with some embodiments.

FIG. 7E is an output image generated by the metasurface when the 1D image of FIG. 7D is used as input, in accordance with some embodiments.

FIG. 7F is an output image produced by an exact spatio-temporal differentiation of the image of FIG. 7D, in accordance with some embodiments.

FIG. 8A is a graphical view of a time-dependent one-dimension (1D) image comprising a segment having a fixed width and moving with different velocities, in accordance with some embodiments.

FIG. 8B is an output image generated by the metasurface when the 1D image of FIG. 8A is used as input, in accordance with some embodiments.

FIG. 8C is a graphical view of a spatio-temporal Fourier Transform of the input signal of FIG. 8A for three different speeds, in accordance with some embodiments.

FIG. 8D is a graphical view illustrating the intensity of the spatio-temporal edges generated by the metasurface when the 1D segment of FIG. 8A is used as input, as a function of the object velocity.

### DETAILED DESCRIPTION

In brief overview, embodiments of the present inventive concept include a metasurface that can perform mixed spatio-temporal differentiation operations of an input image in a compact, analog, and bias-free platform. The spatio-temporal differential operator can be implemented with a nonlocal metasurface, thereby realizing event-based image edge detection by tailoring the nonlocalities in space and time. The passive optical space-time nonlocal metasurface in accordance with some embodiments extends the working principles of metamaterial-based spatial image processing to the temporal domain. In tailoring its frequency response, a metasurface can act as a compact spectral filter, thus performing time-domain computations without using pulse shapers, diffraction gratings, digitalization circuitry, or applied bias. In some embodiments, this is achieved by forming the metasurface from a passive ultrathin silicon-based structured film compatible with standard fabrication techniques, and that operates in the near- and mid-infrared range. For example, unlike pulse shapers, computations are performed within the subwavelength metasurface without additional optical elements. Here, the metasurface detects edges of an object in an image captured by a camera or related sensor only when the object moves, and its design can be tailored to selectively enhance objects moving at desired speeds. The metasurface does not transmit the non-moving objects so they do not appear in the output image, but instead only transmit the edges of the moving objects. The implementation of a passive ultrathin silicon-based structured film allows mixed spatio-temporal differentiation operations to be performed based only on travelling electromagnetic waves, and does not require electronic circuits. In doing so, the device offers extremely high temporal resolution and vanishing latency times. Due to passitivity and the absence of bias, the metasurface-based device in accordance to embodiments is substantially more energy-efficient than conventional device. In particular, conventional metasurface based optical computation techniques are incapable of performing the same computational tasks as the metasurface-based device in accordance with embodiments of the present inventive concept that can perform mixed spatio-temporal differentiation operations without requiring a complicated implementation. In addition, conventional devices providing event-based edge detection are based on active, circuit-based sensors that require high power consumption and pose strict requirements with respect to operational speed and device footprint.

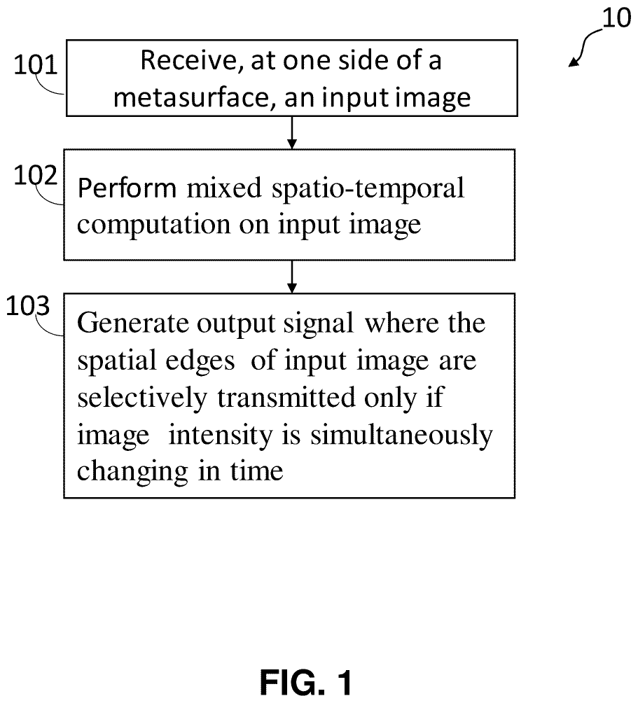

FIG. 1 is a flow diagram of a method 10 for performing analog spatio-temporal differentiation for event-based image processing, in accordance with some embodiments.

At step 101, an input signal is received at one side of a metasurface. In some embodiments, the input signal includes electromagnetic waves providing an input image whose features may depend on space and/or time. In some embodiments, the metasurface is formed of a passive ultrathin silicon-based structured film or the like that allows mixed spatio-temporal differentiation operations to be performed based only on travelling electromagnetic waves.

Accordingly, at step 102, the metasurface performs a mixed spatio-temporal differentiation operation of the input image, realizing event-based edge detection. Here, the metasurface filters the input image and enhances the edges of any object contained in the input image only when the object in the image is moving or changes in time.

At step 103, an output signal outputted from a second side of the metasurface opposite the first side where the input signal is received. The output signal corresponds to the space-time derivative of the input. The output signal is generated where the spatial edges of input image are selectively transmitted only when intensity changes in time. In some embodiments, the metasurface creates an output signal proportional to the spatio-temporal variations of the input signal. As a result, the spatial edges of the input are enhanced only at times when the input intensity is simultaneously varying. In other words, in the calculated output image only the spatio-temporal edges—i.e., the areas where the input image features strong gradients both in space and time are largely enhanced with respect to other areas of the signal.

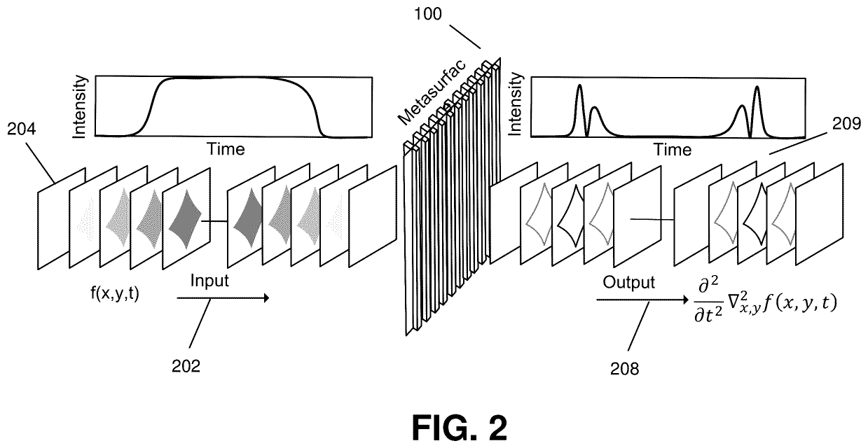

As shown in FIG. 2, a metasurface-based device 100, generally referred to as a metasurface, allows a user to perform a nontrivial mathematical operation, more specifically, a spatio-temporal mixed differentiation, without the need of any applied bias and digitalization, thus avoiding any energy consumption. The metasurface-based device 100 can be formed according to the method 10 of FIG. 1. The metasurface 100 is formed by patterning a layer of silicon to create periodic subwavelength-scale features, constructed and arranged as unit cells that resonantly couple to the electric and magnetic fields of the incident electromagnetic waves, and in doing so exhibit light manipulation properties that do not exist in nature. Other dielectric materials can be used for forming the metasurface 100 such as e.g., silicon nitride, titanium oxide, gallium arsenide, or the like. Depending on the desired operating wavelength. The metasurface 100 utilizes the responses by performing metamaterial-based spatial image processing so that by tailoring its frequency response, the metasurface can act as a compact spectral filter, thus performing time-domain computations without using pulse shapers and diffraction gratings. Besides the drawback of requiring electrical biases and the related power consumption, conventional devices also have limitations in terms of maximum achievable speeds and latency times. In contrast to conventional neuromorphic cameras or the like, the metasurface-based device 100 is fully passive and analog, it does not require any digitalization and applied bias, and it has a vertical footprint comparable to or smaller than the operational wavelength. Moreover, since the metasurface-based device 100 effectively uses electromagnetic radiation to carry and process information, the signal processing occurs at the speed of light.

In some embodiments, the metasurface 100 is constructed and arranged as a passive nonlocal metasurface that can perform analog mixed spatiotemporal differentiation on an input image. The nonlocal feature offers an optical response that is dictated by the coherent interaction between many unit cells due to an additional degree of freedom of interactions between neighboring meta-atoms offered by the nonlocal metasurface. The supporting engineered resonances and/or quasi-bound states in the continuum have been instrumental to tailor nontrivial angle-dependent responses, leading to efficient image-processing devices.

As shown in FIG. 2, a spatio-temporal input signal 202, described by a function f(x, y, t), is encoded in the envelope of a traveling optical wave, with a carrier frequency ω₀ that impinges on a metasurface 100 in accordance with some embodiments. FIG. 2, shows the intensity of the envelope vs. time. The input image 202 is constituted by an object 204, or more specifically, a filled shape, for example, a rhombus, having an intensity that changes in time. In some embodiments, more complicated scenarios can be considered where each of the intensity, shape, and position of the object 204 changes in time.

By judiciously engineering a unit cell of the metasurface 100, the metasurface 100 can impart a different transmission amplitude onto different Fourier components, both in time (temporal) and space (spatial), of the input signal 202. By performing the Fourier filtering in accordance with some embodiments, complicated spatio-temporal operations can be effectively performed on the input signal 202, such that the input signal can be transduced to produce an m an output signal. For example, to perform the mixed spatio-temporal derivative

$$\frac{{\partial }^{m}}{\partial {t}^{m}} \frac{{\partial }^{n}}{\partial {x}^{n}} f ( x , y , t ) ,$$

the metasurface transmission amplitude for a plane wave propagating with frequency ω and with x-component of the in-plane wave vector kₓ must be t^{(m,n)}(kₓ,ω)=kₛⁿ(ω−ω₀)^{m}. Thus, the metasurface 100 must completely suppress plane waves with frequency ω₀, and/or with propagating direction orthogonal to x axis. The expected output signal 208 is generated when the metasurface is designed to perform second-order differentiation in both time and space such that the output signal corresponds to the space-time derivative of the input 202. The output spatio-temporal signal corresponds to the event-based spatio-temporal differentiation of the input. In the output signal 208, the spatial edges 209 of the images are enhanced only when the intensity of the image is strongly changing in time. Two different designs may be provided for a device capable of performing the second-order mixed differentiation

$$\frac{{\partial }^{2}}{\partial {t}^{2}} \frac{{\partial }^{2}}{\partial {x}^{2}} f ( x , t )$$

of the output signal 208.

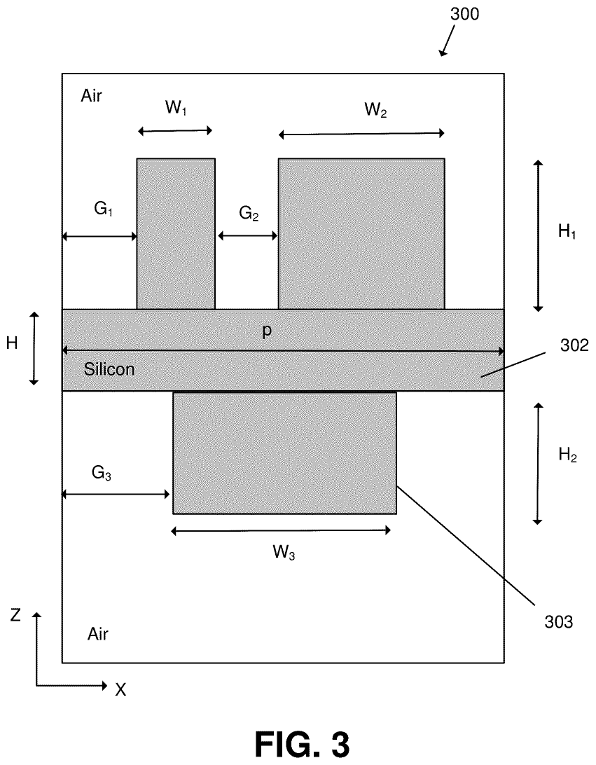

The first design of a metasurface-based device unit cell 300 in accordance with some embodiments is shown in FIG. 3, which comprises a single-layered high-refractive-index slab 302 patterned on both sides. The unit cell 300 may be part of the metasurface-based device 100 of FIG. 2. The patterned slab 302 can be placed either on a transparent substrate such as glass or silica for mechanical handling, or in air. Likewise, the metasurface superstrate (shown in the air regions in FIG. 3) can be either air or a low-index dielectric material.

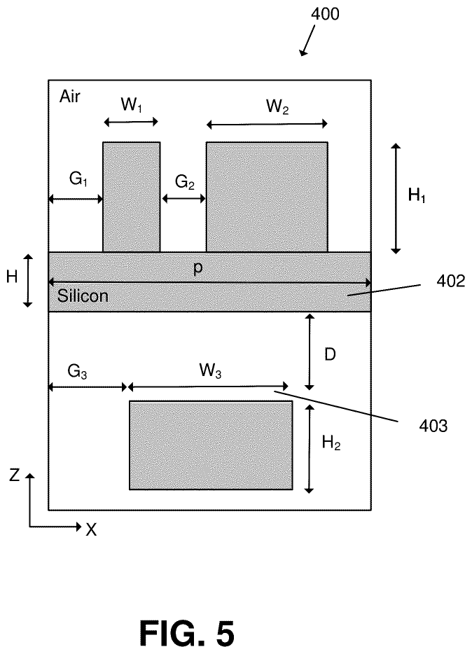

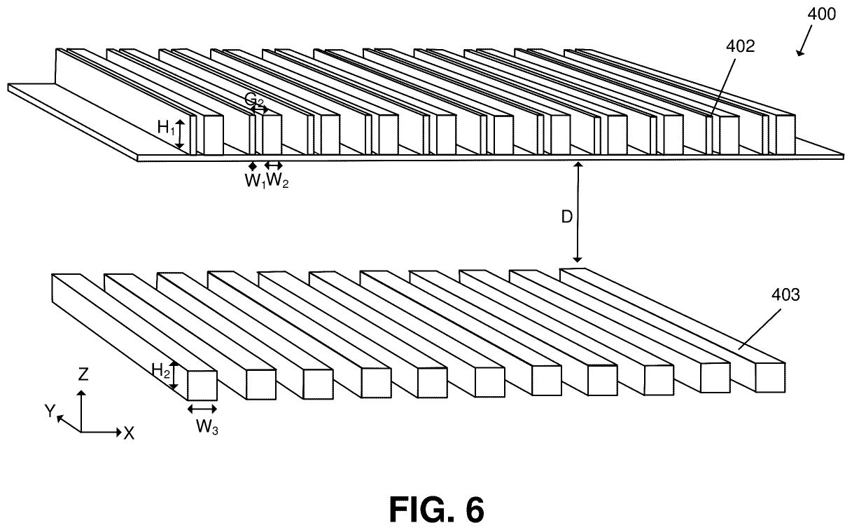

The second design as shown in FIG. 6 comprises a unit cell 400 formed of two cascaded layers of high-refractive-index slabs 402, 403, also referred to herein as layers, as shown in FIGS. 5 and 6. The unit cell 400 may be part of the metasurface-based device 100 of FIG. 2. The two layers 402, 403 can be separated from each other by a predetermined distance D. The two layers 402, 403 can be embedded either in air or in a transparent substrate, such as glass or quartz. A 3D view of the unit cell 400 is shown in FIG. 6. Examples of high-index materials for these devices are: silicon, silicon nitride, titanium oxide, gallium arsenide. In the particular calculations in FIGS. 2-6, silicon is used but not limited thereto. The device 100 can be fabricated either via standard lithographic techniques (ebeam lithography followed by dry or wet etching), or via industrial roll-to-roll large-area fabrication techniques. Both designs (see FIGS. 3-6, respectively) are periodic along the x direction. In this particular case, both designs have a period P=810 nm along the x direction, and they are uniform along the y direction. Although 1D designs are shown, two-dimensional designs can equally apply.

As shown in FIG. 3, the unit cell 300 of the device contains a plurality of rectangular protrusions and gaps, with various aspect ratios, on the two sides of a flat silicon layer 302. In this particular instance, the geometrical dimensions of the first design are W₁=80 nm, W₂=260 nm, W₃=430 nm, H=83 nm, H₁=540 nm, H₂=393 nm, G₂=44.5 nm, G₁=(P−W₁−W₂−G₂)/2 and G₃=(P−W₃)/2. In another example, the parameters are W₁=80 nm, W₂=260 nm, W₃=430 nm, H₁=540 nm, H₂=393 nm, G₁=212.75 nm, G₂=44.5 nm, G₃=190 nm, H=83 nm and P=810 nm. The values of all parameters depend on the operational wavelength, and can vary between 10 nm and 10 microns. The second configuration 400 shown in FIG. 5 comprises two silicon layers 402, 403 arranged in a cascading configuration and separated by a distance (D), noting that distance D=0 in the first configuration shown in FIG. 3, and D>0 in the second configuration shown in FIG. 5. The first layer 402 contains rectangular protrusions and gaps, with various aspect ratios, on one side of a flat silicon layer 402 and the second layer 403 contains rectangular protrusions and gaps. In this particular instance, the geometrical dimensions are W₁=80 nm, W₂=260 nm, W₃=420 nm, H=83 nm, H₁=575 nm, H₂=422 nm, D=2428 nm, G₂=105 nm, G₁=(P−W₁−W₂−G₂)/2 and G₃=(P−W₃)/2. In another example, the parameters are W₁=80 nm, W₂=260 nm, W₃=420 nm, H₁=575 nm, H₂=422 nm, G₁=182.5 nm, G₂=105 nm, G₃=195 nm, H=83 nm, D=2428 nm and P=810 nm. The values of all parameters depend on the operational wavelength and can vary between 10 nm and 10 microns.

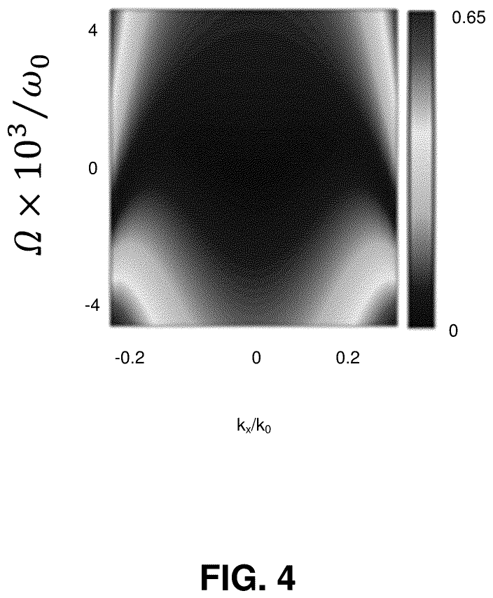

Referring again to FIGS. 2-6, the device 100 (constructed and arranged to include the unit cell 300 of FIGS. 3 and 4 or the unit cell 400 of FIGS. 5 and 6) when excited by an arbitrary spatio-temporal signal can perform analog spatio-temporal differentiation on the input signal 202 shown in FIG. 2. That is, if a travelling optical wave with an amplitude described by a function f(x,y,t) (where x and y are spatial coordinates and t is a time coordinate) impinges on the device 100 from one of its two sides, the optical wave transmitted on the other side of the device 100 will have an amplitude proportional to

$$\frac{{\partial }^{m}}{\partial {t}^{m}} \frac{{\partial }^{n}}{\partial {x}^{n}} f ( x , t ) ,$$

where m and n are nonzero integers. This functionality can be used, for example, to perform analog mathematical operations on an arbitrary spatio-temporal signal. Moreover, it can be used for event-based image processing without the need for any electronic circuitry (as instead required by existing technologies). In other words, the image is processed only when the image intensity is changing in time. In particular, the output field 208 consists of a spatio-temporal signal whereby the spatial edges of the input signal are enhanced only at the instants of time where the intensity of the input image is changing.

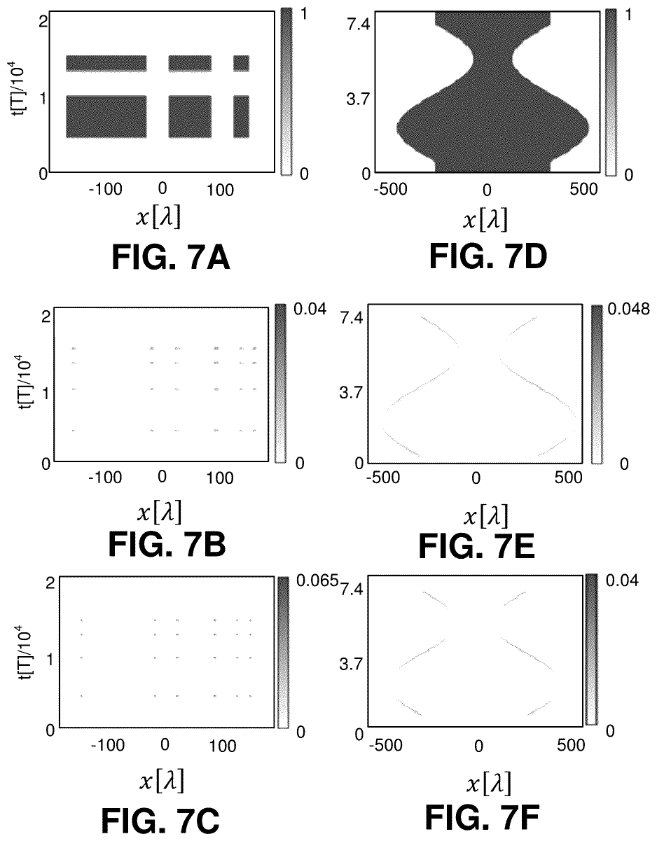

As shown in FIG. 4, the numerically calculated transfer function of the metasurface of the first configuration 300 shown in FIG. 3 is near at or the ideal transfer function, and features an almost zero transmission along the kₓ=0 and ω=ω₀ axis. The transfer function describes how the metasurface affects the transmission of different electromagnetic plane waves, depending on the angle of propagation and frequency of the plane wave. This is evident by the majority of the graph in FIG. 4 being at or near 0 as shown by the gradient bar ranging from 0-0.65, where the higher values approaching the higher limit of 0.65 are shown at the corners of the graph. Using this transfer function, the computational capabilities of this metasurface 100 are numerically verified for different types of input signals and applications. In FIGS. 7A-7F, the case of a 1D input image comprising one or more segments is processed. It is assumed that either the intensity of the segment(s) having a fixed size is quickly switching in time on and off, i.e., between 0 and 1 (FIG. 7A), or that the width of the segment is changing in time (FIG. 7D). FIGS. 7D-7F are similar to FIGS. 7A-7C, but with a different spatio-temporal input, comprising a single segment whose width changes in time.

In both cases (FIGS. 7A-7C and 7D-7F), the calculated spatio-temporal output signals (see FIGS. 7B and 7E, respectively), show the expected features. In FIG. 7B, the corresponding output image is calculated using the transfer function of the metasurface device. In FIG. 7C, the corresponding output image is calculated using an ideal transfer function which performs exactly the desired mathematical operation. More specifically, FIG. 7C is the mathematical differentiation of the input in FIG. 7A. Here the metasurface output is compared with an ideal mathematical reference. In both cases, the spatial edges of the image are enhanced only when the image intensity or the image shape is evolving in time. The correctness and quality of the mathematical operations performed by the analog metasurface 100 can be further verified by comparing the numerical calculations (FIGS. 7B, 7E) based on the transfer function in FIG. 4 with the corresponding signals obtained with an ideal transfer function, which implements exactly the second-order mixed derivatives, as shown in FIGS. 7C and 7F, respectively. In FIGS. 7C and 7F, the output image is calculated using an ideal transfer function. The close resemblances between the images shown in FIGS. 7B, 7E and FIGS. 7C, 7F confirm that the metasurface design in accordance with embodiments of the present inventive concept can effectively impart the

$$\frac{{\partial }^{2}}{\partial {t}^{2}} \frac{{\partial }^{2}}{\partial {x}^{2}}$$

operator on the input image.

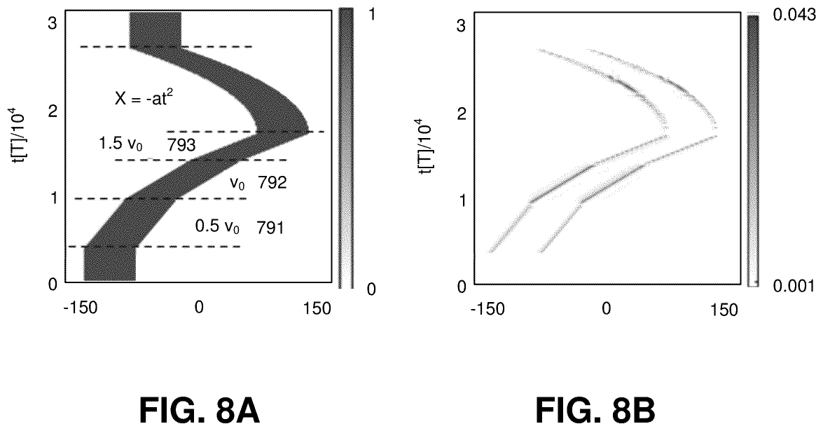

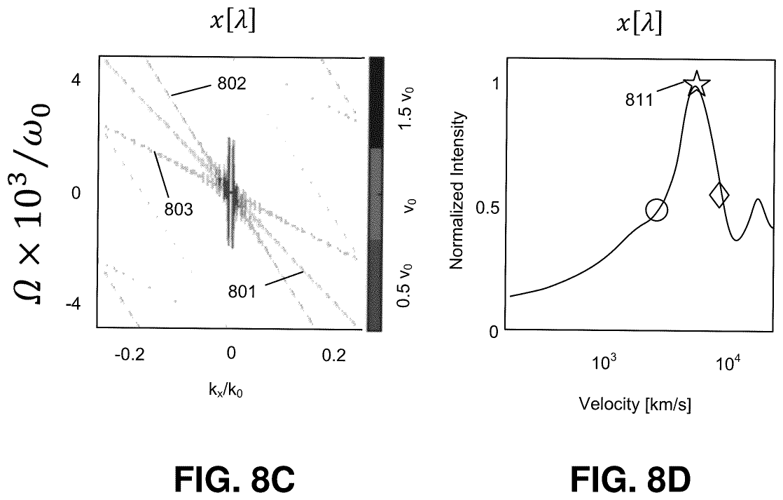

In some embodiments, the metasurface 100 can also perform an analog event-based edge detection operation. That is, it enhances the edges of an object only when the object is moving. In FIG. 8A, shown is a graphical view of a one-dimension (1D) object undergoing a non-uniform motion. The object, or more specifically the segment, is initially at rest, and then it starts moving with constant velocities 0.5 V₀ (791), V₀ (792) and 1.5 V₀ (793). In the first part of the movement, the object maintains a constant speed equal to 0.5 V₀ (791). The speed then increases in discrete steps, first to V₀ (792) and then to 1.5V₀ (793). The characteristic speed is defined as v₀=cNAₜ/NA, where c is the speed of light, NA=0.26 is the numerical aperture of the device (defined by the extent of the horizontal axis in FIG. 4 or 8C), and NAₜ=0.005 is the temporal numerical aperture (defined by the extent of the vertical axis in FIG. 4 or 8C). Both numerical aperture (NA) and temporal numerical aperture (NAₜ) can be widely tunable by tailoring the response function of the metasurface 100. In the last part of the motion shown in FIG. 8A, the object accelerates in the opposite direction and finally stops.

FIG. 8B shows the corresponding calculated output signal generated by the metasurface 100. Shown in FIG. 8B is the intensity of the output signal, highlighting the spatiotemporal edges. The edges of the object in the output image (FIG. 8B) are not enhanced during the time that the object is not moving in the input image (FIG. 8A), but they become strongly visible as soon as the object starts moving. The intensity of the edges depends on the speed at which the object is moving, and the maximum intensity is obtained when the object moves at a speed equal to vₒ. This effect is due to the fact that the spatio-temporal Fourier transform of an object moving with uniform speed equal to vₒ (trace 801 in FIG. 8C) aligns optimally with the highly transmissive regions of the transfer function shown in FIG. 4. Instead, for objects propagating a different speed (see blue and green traces 802 and 803 in FIG. 8C), the corresponding Fourier transform mainly lies in regions where the transfer function has lower values.

FIG. 8D shows how the intensity of the edges of an object depends on the object speed, assuming that the metasurface 100 in FIGS. 2-4 is used. Shown in particular is the intensity of the spatio-temporal edges versus the speed of the segment. As expected, the intensity peaks at v₀=c NAₜ/NA≈5800 km/s (denoted by the star 811 corresponding to the trace 801 in FIG. 8C), and it decreases when the speed is either lower or higher than this optimal value. Nonetheless, the intensity is still fairly large (~20% of the maximum one) for speeds that are more than one order of magnitude smaller than v₀. The circle in FIG. 8D corresponds to the green trace 803 of FIG. 8C and the star in FIG. 8D corresponds to the blue trace 802 in FIG. 8C. The optimal speed v₀ is determined by the spatial and temporal numerical apertures of the metasurface, and it can be controlled by varying one or both of them. Both numerical aperture (NA) and temporal numerical aperture (NAₜ) can be widely tunable by tailoring the geometry of the metasurface 100. For a fixed temporal numerical aperture NAₜ, v₀ can be decreased by increasing the spatial numerical aperture NA, which would also increase the spatial resolution. For the device shown in FIGS. 2-4 (NA=0.26), for example, the characteristic speed v₀ could be decreased by a factor of about 4 by working with larger spatial NAs→1. Alternatively, for a fixed spatial numerical aperture, v₀ can be reduced by reducing the temporal numerical aperture NAₜ. We have also optimized different metasurface designs with v₀≈3,000 km/s and v₀≈1825 km/s.

Referring again to an analog optical device of FIGS. 2-8, some embodiments may include the device transducing a spatio-temporal signal f(x,y,t) carried by an electromagnetic input signal with carrier frequency ω₀ impinging on a first side of the analog optical device, and producing an output signal fₒᵤₜ(x,y,t) carried by an electromagnetic wave at a frequency equal to the electromagnetic input signal, the output signal being outputted from a second side of the analog optical device opposite the first side. The output signal fₒᵤₜ(x,y,t) is carried by an electromagnetic wave at a frequency equal to the electromagnetic input signal, Here, the device does not change the carrier frequency, but it only modifies the envelope of the signal by performing the spatio-temporal differentiation.

Here, the output signal is given by a mixed spatio-temporal derivative operation,

$${f}_{out} ( x , y , t ) = ( {\partial }_{x}^{n} + {\partial }_{y}^{p} ) {\partial }_{t}^{m} f ( x , y , t ) .$$

A desired computational operation

$$f ( x , y , t ) \to {f}_{out} ( x , y , t ) = ( {\partial }_{x}^{n} + {\partial }_{y}^{p} ) {\partial }_{t}^{m} f ( x , y , t )$$

is achieved by designing the analog optical device such that a plane wave with frequency ω and in-plane wavevectors kₓ and k_{y}, impinging on the analog optical device from the first side, is transmitted to the second side with transmission amplitude t^{(n,p,m)}(kₓ,k_{y},ω) ≡[(ikₓ)+(ik_{y})^{p}](ω− ω₀)^{m}. In some embodiments, the analog optical device has an overall thickness smaller than an operational wavelength λ₀=2πc/ω₀ (where c is the speed of light). The analog optical device can comprise a spatial layer and a temporal layer which are cascaded along a direction of propagation of the electromagnetic input signal, shown for example in FIGS. 3-6. The spatial layer performs a spatial differential operation on the electromagnetic input signal,

$$f ( x , y , t ) \to ( {\partial }_{x}^{n} + {\partial }_{y}^{p} ) f ( x , y , t ) ,$$

and the temporal layer performs a temporal differential operation

$$f ( x , y , t ) \to {\partial }_{t}^{m} f ( x , y , t )$$

on the incoming signal. The spatial layer 302, 402 is designed such that a plane wave with in-plane wavevectors kₓ and k_{y}, impinging on the analog optical device from the first side, is transmitted to the second side, with transmission amplitude t^{(n,p)}(kₓ,k_{y},ω)≡(ikₓ)ⁿ+(ik_{y})^{p}, and the temporal layer 303, 403 is designed such that a plane wave with frequency ω, impinging on the analog optical device from the first side, is transmitted to the second side with transmission amplitude t^{(m)}(kₓ,k^{y},ω)≡(ω−ω₀)^{m}. In some embodiments, the spatial layer and temporal layer are each comprise of respective optical metasurfaces with overall thickness smaller than the operational an operating wavelength λ₀. Each metasurface may comprise a planarized structure made of a first material with a refractive index n₁ with the first side and the second side, and a plurality of first features on the first side made of the same material, and a plurality of second features on the second side made of the same material. The planarized structure is immersed in a material with a refractive index n₂ smaller than n₁. The material may be formed of air, glass, silicon dioxide, or the like. The first and second features are repeated periodically along a direction parallel to the plane of the planarized structure with a periodicity p, the periodicity p being greater than the operating wavelength λ₀. In some embodiments, the first material is a material with index of refraction larger than 1.5, and the second material is a material with index of refraction between 1 and 2. In some embodiments, referring to FIG. 5 (where distance (D) is greater than 0), the unit cell 400 has an optical metasurface of a spatial layer comprised of the first material with thickness H and a periodic arrangement of a first rectangular protrusion and a second rectangular protrusion, both comprised of the first material on a top side, and is immersed in a medium made of the second material. The first rectangular protrusion has a height H₁ and a width W₁, and the second rectangular protrusion has a height H₁ and a width W₂, the first rectangular protrusion and the second rectangular protrusion being separated by a gap G₂, the first rectangular protrusion and the second rectangular protrusion are repeated along an x direction with the periodicity p. In some embodiments, the optical metasurface of the temporal layer 403 is comprised of a periodic arrangement of a single rectangular protrusion made of the first material and is immersed in a medium made of the second material, the rectangular protrusion has height H₂ and width W₃, and is repeated along an x direction with the periodicity p. In some embodiments, the optical metasurfaces of the spatial layer 402 and temporal layer 403 are embedded in a matrix made of the second material and separated by a vertical gap D. In some embodiments, the optical metasurfaces of the spatial layer 402 and the temporal layer 403 are contiguous. In some embodiments, the analog optical device performs a mixed second-order derivative

$$f ( x , y , t ) \to {\partial }_{x}^{2} {\partial }_{t}^{2} f ( x , y , t ) .$$

In some embodiments, the operating wavelength λ₀ is a value between 400 nanometers and 4 microns;

$$P = 0.53 \frac{{λ}_{0}}{{n}_{1}} \pm 10 \% ; H = 0.05 \frac{{λ}_{0}}{{n}_{1}} \pm {H}_{1} =$$

$$0.38 \frac{{λ}_{0}}{{n}_{1}} \pm 10 \% ; {W}_{1} = 0.05 \frac{{λ}_{0}}{{n}_{1}} \pm 10 \% ; {W}_{2} = 0.17 \frac{{λ}_{0}}{{n}_{1}} \pm 10 \% ; {G}_{2} = 0.07 \frac{{λ}_{0}}{{n}_{1}} \pm 10 \% ; {H}_{2} =$$

$$0.28 \frac{{λ}_{0}}{{n}_{1}} \pm 10 \% ; and {W}_{3} = 0.28 \frac{{λ}_{0}}{{n}_{1}} \pm 10 \% .$$

In some embodiments, the operating wavelength λ₀ is between 400 nanometers and 4 microns;

$$P = 0.57 \frac{{λ}_{0}}{{n}_{1}} \pm 10 \% ; H = 0.05 \frac{{λ}_{0}}{{n}_{1}} \pm 10 \% ; {H}_{1} = 0.38 \frac{{λ}_{0}}{{n}_{1}} \pm 10 \% ; {W}_{1} = 0.06 \frac{{λ}_{0}}{{n}_{1}} \pm$$

$$10 \% ; {W}_{2} = 0.18 \frac{{λ}_{0}}{{n}_{1}} \pm 10 \% ; {G}_{2} = 0.03 \frac{{λ}_{0}}{{n}_{1}} \pm 10 \% ; {H}_{2} = 0.28 \frac{{λ}_{0}}{{n}_{1}} \pm 10 \% ; {W}_{3} = 0.30 \frac{{λ}_{0}}{{n}_{1}} \pm 10 \% ;$$

$$and D = 1. 89 \frac{{λ}_{0}}{{n}_{1}} \pm 10 \% .$$

Another aspect of a passive optical metasurface of FIGS. 2-8 may comprises a planar metasurface comprising a means for transducing a spatio-temporal input signal f(x,y,t) to a spatio-temporal output signal

$$\frac{{\partial }^{2}}{\partial {t}^{2}} {∇}_{x , y}^{2} f ( x , y , t )$$

such that only regions of the spatio-temporal input signal f(x,y,t) with simultaneous nonzero spatial and time gradients are transduced. The planar metasurface comprises a first side and second side opposite the first side. The first side comprising means for performing a spatial differential operation

$$f ( x , y , t ) \to ( {\partial }_{x}^{n} + {\partial }_{y}^{p} ) f ( x , y , t )$$

on an incoming signal. The second side comprises means for performing a temporal differential operation

$$f ( x , y , t ) \to {\partial }_{t}^{m} f ( x , y , t )$$

on the incoming signal, for example, described herein but not limited thereto.

As described above, the planarized, ultrathin, and patterned analog optical device, or metasurface, in accordance with some embodiments is constructed and arranged for all-optical computation with applications in neural networks and neuromorphic computing. However, other applications and uses of the passive optical metasurface may equally apply such as, but not limited to, feature detection and tracking, optical flow estimation, three dimensional (3D) reconstruction monocular and stereo, pose estimation and simultaneous localization and mapping (SLAM), image reconstruction, motion segmentation, recognition, real-time on-board robotics, liquid monitoring, vibration monitoring, machine learning, and augmented reality, or a combination thereof. While the invention has been described with reference to certain embodiments, it will be understood by those skilled in the art that various changes may be made and equivalents may be substituted for elements thereof to adapt to particular situations without departing from the scope of the disclosure. Therefore, it is intended that the claims not be limited to the particular embodiments disclosed, but that the claims will include all embodiments falling within the scope and spirit of the appended claims.

What is claimed is:

1. An imaging device, comprising:
an input region that receives an input signal encoded in an envelope of an electromagnetic wave;
a metasurface comprising a periodic repetition of unit cells comprising at least one layer that is patterned to perform a spatio-temporal operation on the input signal; and
an output region that generates an expected output signal that corresponds to a space-time derivative of the input signal.

2. The imaging device of claim 1, wherein the input signal is a spatio-temporal input signal including a time-varying image.

3. The imaging device of claim 1, wherein the input signal includes an image having a shape that having an intensity that changes in time.

4. The imaging device of claim 1, wherein the at least one layer includes a periodic arrangement of protrusions separated by at least one gap.

5. The imaging device of claim 1, wherein the analog optical device comprises a spatial layer and a temporal layer which are cascaded along a direction of propagation of the electromagnetic input signal.

6. The imaging device of claim 1, wherein the spatial layer and the temporal layer are separated by a vertical gap.

7. The imaging device of claim 1, wherein the metasurface performs the spatio-temporal operation, including an analog event-based edge detection operation that enhances the edges of an object in the input signal only when the object is moving.

8. The imaging device of claim 1, wherein the spatio-temporal operation includes a Fourier filtering operation that performs a second order mixed differentiation in both time and space so that spatial edges of an image of the input signal is enhanced only when an intensity of the image changes in time.

9. An analog optical device comprising a means for transducing a spatio-temporal signal f(x,y,t) carried by an electromagnetic input signal with a carrier frequency ω₀ impinging on a first side of the analog optical device, and producing an output signal fₒᵤₜ(x,y,t) carried by an electromagnetic wave at a frequency equal to the electromagnetic input signal, the output signal being outputted from a second side of the analog optical device opposite the first side.

10. The analog optical device as recited in claim 9, wherein the output signal is given by a mixed spatio-temporal derivative operation.

11. The analog optical device as recited in claim 9, wherein a desired computational operation is achieved by designing the analog optical device such that a plane wave impinging on the analog optical device from the first side is transmitted to the second side with a transmission amplitude t^{(n,p,m)}(λₓ,λ_{y},ω)≡[(ikₓ)ⁿ+(ik_{y})^{p}](ω−ω₀)^{m}.

12. The analog optical device as recited in claim 9, wherein the analog optical device has an overall thickness smaller than an operational wavelength λ₀=2πc/ω₀ (where c is the speed of light).

13. The analog optical device as recited in claim 9, wherein the analog optical device comprises a spatial layer and a temporal layer which are cascaded along a direction of propagation of the electromagnetic input signal.

14. The analog optical device as recited in claim 13, wherein the spatial layer performs a spatial differential operation on the electromagnetic input signal,
$$f ( x , y , t ) \to ( {\partial }_{x}^{n} + {\partial }_{y}^{p} ) f ( x , y , t ) ,$$
and the temporal layer performs a temporal differential operation
$$f ( x , y , t ) \to {\partial }_{t}^{m} f ( x , y , t )$$
on the incoming signal.

15. The analog optical device as recited in claim 13, wherein the spatial layer is designed such that a plane wave with in-plane wavevectors λₓ and λ_{y}, impinging on the analog optical device from the first side, is transmitted to the second side, with transmission amplitude t^{(n,p)}(λₓ, λ_{y}, ω) ≡(ikₓ)ⁿ+(ik_{y})^{p}, and the temporal layer is designed such that a plane wave with frequency ω, impinging on the analog optical device from the first side, is transmitted to the second side with transmission amplitude t^{(m)}t(λₓ, λ_{y}, ω)≡(ω−ω₀)^{m}.

16. The analog optical device as recited in claim 5, wherein the spatial layer and temporal layer are each comprise of respective optical metasurfaces with overall thickness smaller than an operating wavelength λ₀, each metasurface comprising:
a planarized structure with the first side and the second side, the planarized structure comprises a first material with a refractive index n₁ with the first side and the second side, and a plurality of first features on the first side made of the same material, and a plurality of second features on the second side made of the same material, wherein the planarized structure is immersed in a material with a refractive index smaller than the refractive index n₁, and wherein first and second features are repeated periodically along a direction parallel to the plane of the planarized structure with a periodicity greater than the operating wavelength.

17. The analog optical device as recited in claim 9, wherein
a. the optical metasurface of the spatial layer is comprised of the first material with thickness H and a periodic arrangement of a first rectangular protrusion and a second rectangular protrusion, both comprised of the first material on a top side, and is immersed in a medium made of the second material, the first rectangular protrusion has height H₁ and width ω₁, and the second rectangular protrusion has height H₁ and width ω₂, the first rectangular protrusion and the second rectangular protrusion being separated by a gap G₂, the first rectangular protrusion and the second rectangular protrusion are repeated along an x direction with the periodicity p.
b. the optical metasurface of the temporal layer is comprised of a periodic arrangement of a single rectangular protrusion made of the first material and is immersed in a medium made of the second material, the rectangular protrusion has height H₂ and width ω₃, and is repeated along an x direction with the periodicity p.

18. The analog optical device as recited in claim 17, wherein the optical metasurfaces of the spatial layer and temporal layer are embedded in a matrix made of the second material and separated by a vertical gap D.

19. The analog optical device as recited in claim 17, where the optical metasurfaces of the spatial layer and the temporal layer are contiguous.

20. A passive optical metasurface comprising:
a planar metasurface comprising a means for transducing a spatio-temporal input signal f(x, y, t) to a spatio-temporal output signal
$$\frac{{\partial }^{2}}{\partial {t}^{2}} {∇}_{x , y}^{2} f ( x , y , t )$$
such that only regions of the spatio-temporal input signal f(x, y, t) with simultaneous nonzero spatial and time gradients are transduced.
